(19) United States
(12) Patent Application Publication
(10) Pub. No.: US 2017/0298847 A1
(43) Pub. Date: Oct. 19, 2017

(54) MODULES AND SUB-MODULES FOR USE IN CONVERTING A MARINE VESSEL TO GASEOUS FUEL

(71) Applicant: Blue Gas Marine, Inc., Apex, NC (US)

(72) Inventor: Jose Miguel Patricio GUERREIRO, Apex, NC (US)

(21) Appl. No.: 15/641,612

(22) Filed: Jul. 5, 2017

Related U.S. Application Data
(63) Continuation of application No. PCT/US16/12394, filed on Jan. 6, 2016.
(60) Provisional application No. 62/100,452, filed on Jan. 6, 2015.

(51) Int. Cl. F02D 41/00; F02M 21/02; F02D 41/22; B63B 17/00; B63H 21/38; F02P 5/04

(52) U.S. Cl. CPC F02D 41/0027; F02P 5/04; F02M 21/0293; F02M 21/029; F02M 21/0281; F02M 21/0239; F02M 21/0221; B63B 17/0027; F02M 21/0215; B63H 21/38; F02D 41/22; B63B 2770/00; F02D 2200/0602; F02D 2200/101; F02D 2400/11

(57) ABSTRACT

A system is provided. The system includes a fuel receiving module configured for being installed within a marine vehicle, the fuel receiving module including at least a fuel receptacle. A tank module for storing gaseous fuel is provided. The tank module is in communication with the fuel receiving module. A pressure reduction module is configured for reducing a pressure of the gaseous fuel from the tank module to a pressure suitable for an engine of the marine vehicle. An engine module is in communication with an engine control module for controlling operation of the engine. A helm control module is in communication with the engine module and at least one other module for controlling operation of the system.

### CROSS-REFERENCE TO RELATED APPLICATION

This application is a continuation of International Patent Application Serial No. PCT/US16/12394, filed 6 Jan. 2016, entitled “Modules and Sub-Modules for Use in Converting a Marine Vessel to Gaseous Fuel”, which claims the benefit of and priority to U.S. Provisional Patent Application No. 62/100,452 filed on 6 Jan. 2015, all of which are incorporated by reference herein.

### TECHNICAL FIELD

This disclosure is directed towards a natural gas conversion system for marine vessels, and, more particularly, towards modules and sub-modules for use in converting a marine vehicle to gaseous fuel for producing improved marine vessel engines having reduced emissions and increased performance.

### BACKGROUND

Natural gas is a clean burning fuel (relative to gasoline and diesel) with improved emission levels of hydrocarbons, nitrogen oxides (NOₓ), carbon oxides (COx) and particulate matter. Increasing concern over exhaust emissions regulation and fuel efficiency has led to an interest in burning a combustible gaseous fuel, such as propane, hydrogen or natural gas in engines.

This interest is even more pronounced with regards to marine vessels. Marine vessels are many times less efficient than land-based vehicles due to the energy demands of cutting through water. This inefficiency has led to increased amounts of pollution, in particular as it relates to pollution of water bodies and adjacent air. Furthermore, increasing costs associated with gasoline and diesel fuels have dramatically increased the cost of operation for marine vessel operators.

Due to recent advances in technology for harnessing natural gas, natural gas has become an attractive alternative to gasoline and diesel fuels, however, upfitting and/or retrofitting an existing fleet of marine vessels with natural gas enabled technology has been overly expensive and a logistics challenge since it commonly requires replacing the existing engines with new engines. New dual-fuel engines exist only for very large ships, leaving the majority of boats without alternatives for burning cheaper and cleaner fuels.

The installation of all the individual components and the creation of their flow and electrical connections to assemble a complete gaseous fuel-system requires a level of skill and training so advanced that professionals with these skills are generally not available at the marine service centers that would perform marine vessel conversion installation to alternative gaseous fuels. This installation would also be very expensive and time consuming requiring many engineers to work as a team to return a converted vessel back into commercial operation in an acceptable timeframe. Therefore, the creation of plug-and-plug modules with pre-assembled sub-assemblies that are easily mounted and interconnected by marine technicians with a basic level of mechanical and electrical skills is highly desirable since these are the technicians generally available in the marine industry, throughout the world. Modularizing the system allows for a very fast installation onboard a marine vessel and significantly increases the economic feasibility of conversion installations to alternative gaseous fuels on marine vessels and the increased performance and reduced pollution inherent to these fuels.

Accordingly, a need exists for a solution to these problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein is a system. The system includes a fuel receiving module configured for being installed within a marine vessel, the fuel receiving module including at least a fuel receptacle. A tank module for storing gaseous fuel is provided. The tank module is in communication with the fuel receiving module. A pressure reduction module is configured for reducing a pressure of the gaseous fuel from the tank module to a pressure suitable for one or more engines of the marine vessel. An engine module is in communication with an engine control module for controlling operation of the engine under gaseous fuel operation. A helm control module is in communication with the engine module and at least one other module for controlling operation of the system and displaying information to the operator. An ignition control module may also be provided to increase performance in certain engine types.

According to one or more embodiments, the pressure reduction module is in communication with a heating module for applying heating to the pressure reduction module to prevent freezing thereof during pressure reduction caused by the fuel discharge of the gaseous fuel.

According to one or more embodiments, the heating module includes a pump that is configured for being fluidly coupled to an ambient liquid supply. The pump pumps ambient liquid to the pressure reduction module when directed by the helm control module.

According to one or more embodiments, the engine module includes an injector adaptor for each cylinder of the engine. The adaptor may be of the type having a body portion defining a chamber therein and having a first end configured for being received within the engine and a second end configured engaging with the fuel injector and a fuel passage inlet having a first end spaced-apart from the body portion that is configured for fluid communication with a gaseous fuel supply and a second end terminating in an inlet opening defined in the body portion, the inlet opening defining an oblong shape and terminating in the body at a position below the bottom-most portion of the injector.

According to one or more embodiments, the engine module is configured for controlling an a fuel injector in fluid communication with a cylinder head of the engine and a supply line having a valve for controlling flow of the gaseous fuel therethrough, the control module being configured to enable the fuel injector when the engine is operating at a first predetermined operation condition and configured to enable the valve when the engine is operating at a second predetermined operation condition, wherein the first predetermined operation condition is an engine RPM below a predetermined value.

According to one or more embodiments, the second predetermined operation condition is an engine RPM above a predetermined value.

According to one or more embodiments, the control module is configured to shut off the fuel injector and actuate the valve to the open position when the engine transitions from the first predetermined operation condition to the second predetermined operation condition such that the engine is cranked on gasoline or diesel from the respective gasoline or diesel fuel source but runs on gaseous fuel between a desired RPM range.

According to one or more embodiments, the control module is configured to actuate the valve to vary the duration of opening to vary the amount of gaseous fuel flowing therethrough.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a schematic of a variety of modules for use with the systems disclosed herein according to one or more embodiments disclosed herein where the modules are shown in flow communication;

FIG. 2 is a schematic of a variety of modules for use with the systems disclosed herein according to one or more embodiments disclosed herein where the modules are shown in electrical or signal communication;

FIG. 3 is a perspective view of a tank for use with a fueling module according to one or more embodiments disclosed herein;

FIG. 4 is a perspective view of a bracket for mounting the tank of FIG. 3 according to one or more embodiments disclosed herein;

FIG. 5 is a perspective view of a bracket for mounting the tank of FIG. 3 according to one or more embodiments disclosed herein;

FIGS. 6A and 6B are views of the fuel receiving panel according to one or more embodiments disclosed herein; and

FIGS. 7A and 7B are views of the fuel receiving panel according to one or more embodiments disclosed herein.

### DETAILED DESCRIPTION

The presently disclosed subject matter is described with specificity to meet statutory requirements. However, the description itself is not intended to limit the scope of this patent. Rather, the inventor(s) have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

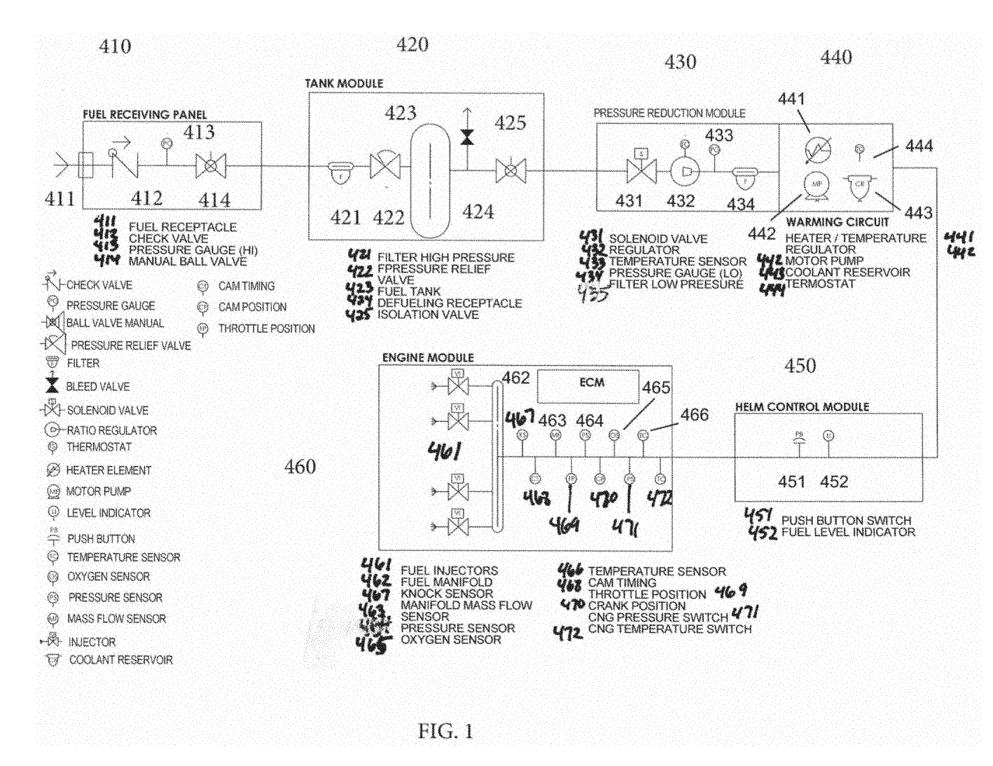

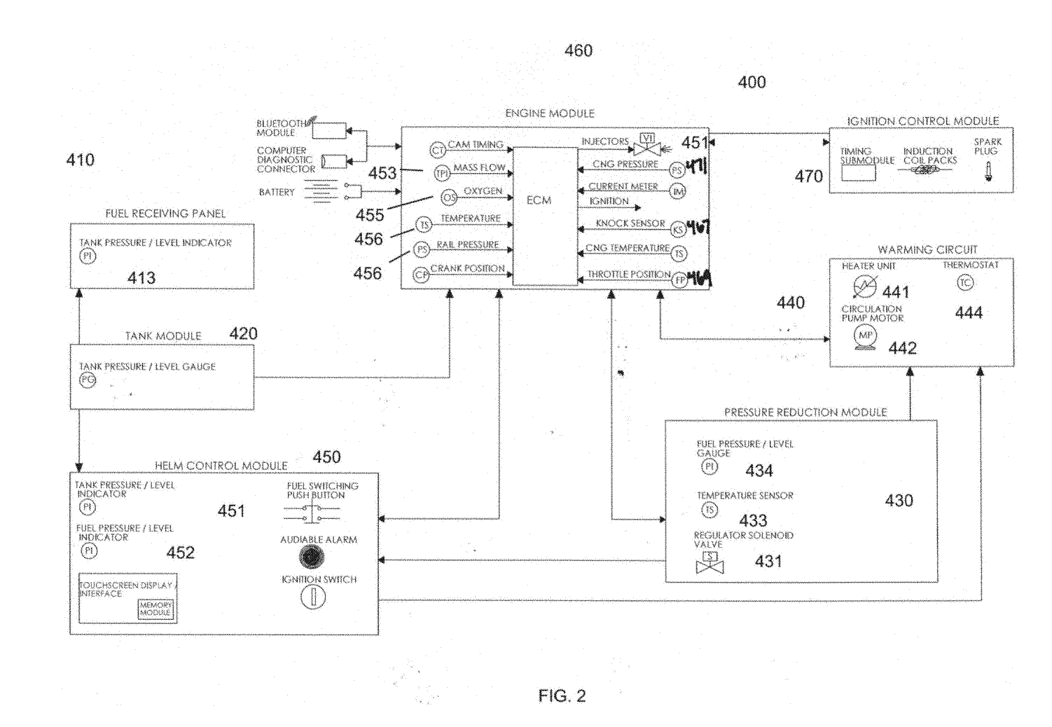

A schematic illustration of a system including an engine module that includes the control module and engine is illustrated in FIG. 1 and FIG. 2, with the control module being designated 130. FIG. 1 illustrates a flow diagram of fuel flow, with successive modules being “downstream” of the prior module. FIG. 2 illustrates a diagram of electrical or other communication lines between respective modules.

As illustrated, various components forming system 400 are illustrated. A fuel receiving panel 410 includes a fuel receptacle 411. The fuel receptacle 411 is configured for engaging with a high pressure fuel source to allow fueling of a tank further described in tank module 420. A check valve 412 is provided downstream of the fuel receptacle 411 to prevent reverse discharge of fuel. A pressure gauge 413 may be provided downstream of the check valve 412. A manual ball valve 414 may be provided downstream of the pressure gauge 413 for allowing flow of fuel towards tank module 420.

The tank module 420 includes a high pressure filter 421 at about an inlet of the module 420. A pressure relief valve 422 may be provided downstream of the filter 421 in order to manually relive any pressure contained within the supply lines. A fuel tank 423 is provided within tank module 420. The fuel tank 423 may be oriented vertically or horizontally within a marine vessel. The tank 423 may be mounted on a deck, or within a bench, cooler, hull, or the like. A series or parallel arrangement of tanks 423 may also be provided for increasing storage capacity. A defueling receptacle 424 may also be provided downstream of the tank 423 to allow for defueling of the tank for maintenance, storage, or other purposes. A bleed valve 424 that acts as a defueling receptacle is also provided downstream of the tank 423. In this manner, the tank may be defueled when desired for maintenance or storage purposes. An isolation valve 425 may also be provided. A tank pressure/level gauge may also be provided. The tank module 420 is both downstream from a flow standpoint and downstream from a communications standpoint from the fuel receiving panel 410.

A pressure reduction module 430 is provided for reducing the pressure from tank module 420 into a usable pressure suitable for engine injection use. As an example, a suitable engine pressure may be at about 40 PSI. The pressure reduction module 430 is thus provided to reduce the pressure to about 40 PSI in one example. The pressure reduction module 430 may include a solenoid valve 431. The solenoid valve 431 is provided for selectively allowing flow of gaseous fuel from the tank module 420 into the pressure reduction module 430. A regulator 432 may be provided for reducing the pressure from the tank 423 to a suitable pressure. Due to the cooling effect of high pressure being reduced to low pressure, a warming module 440 is provided within the pressure reduction module 430 in order to provide defrosting or other warming characteristics to the pressure reduction module 430 in whole, and, more specifically to the regulator 432. A temperature sensor 433 monitors the temperature of the regulator 432. A pressure gauge 434 monitors the regulated pressure from regulator 432. A low pressure filter 435 is also provided. The pressure reduction module 430 is in communication with the warming circuit 440 from a flow standpoint, and in communication with the warming circuit 440, engine module 460, and helm control module 450 from a communications standpoint.

The warming module 440 may include a heater or other temperature regulator 441. This temperature regulator 441 may be a heat pump or a direct heater such as an infrared or other heating element, or could use a liquid pump 442 to pump fluids from a coolant reservoir 443. As used herein, coolant reservoir could be warming fluids from a tank or other reservoir on board of the vehicle, such as a marine vehicle or boat, or could be pumped from ambient such as from a body of water that the vessel is on. In this manner, no additional storage tank would be required. A thermostat 444 could be provided to selectively allow discharge of warming fluids only when desired. The ECM or some other computer control module could also monitor the temperature sensor 433 and direct the motor pump 442 to pump warming liquids from the ambient or a liquid reservoir whenever the monitored temperature is below a predetermined value or is changing at a rate that triggers application of warming fluids. For example, if the monitored temperature drop is increasing at an unacceptably high rate, the motor pump 442 may pump warming fluids before an otherwise critical temperature is reached in order to avoid dropping below a critical temperature as ambient warming fluids are pumped through supply lines.

A helm control module 450 may also be provided. The helm control module 450 is provided for purposes of retrofitting a gasoline or diesel powered engine to be bi-fuel or gaseous fuel operated. The helm control module 450 includes a push button switch 451 that cycles between liquid fuel and gaseous fuel for the engine. A fuel level indicator 452 may also be provided for monitoring the fuel level in tank 423. The helm control module 450 may include an audible alarm for alerting the user to one or more events. The helm control module 450 may include an ignition switch, a tank pressure/level indicator, a fuel pressure/level indicator, and a touchscreen display or interface. The interface may be included with a memory module. The helm control module 450 may be in communication with the tank module 420, the engine module 460, the pressure reduction module 430, and the warming circuit 440.

An engine module 460 may be provided. The engine module 460 is advantageously provided for supplying the necessary components to convert a gasoline or diesel powered engine to be bi-fuel or gaseous fuel operated. The engine module 460 may include the fuel injectors 461 already provided with the engine, along with the fuel manifold 462. A mass flow sensor 463 may be provided for monitoring flow rate and other characteristics. A pressure sensor 464, oxygen sensor 465, and temperature sensor 466 may also be provided. Each of these items may be in communication with ECM 130. A knock sensor 467 may also be provided for detecting engine knock. A cam timing sensor 468 may be providing for monitoring cam timing. The control modules disclosed herein may be configured for modifying cam timing depending on the fuel being used, the ratio of fuel being used, the RPMs of the engine, ambient temperatures, and the like. A throttle position sensor 469 may be provided for monitoring a position of the throttle of the engine. A crank position sensor 470 may also be provided. A pressure sensor 471 may be provided for monitoring pressure in the engine. A CNG temperature switch 472 may also be provided.

An ignition control module 470 may also be provided. The module 470 may include a timing submodule. The timing submodule may be configured for altering the timing or duration of the ignition spark. This may be done in communication with signaling received from the engine module 460. Induction coil packs may be provided as part of the ignition control module 470 and there may be one induction coil pack for each engine cylinder. A spark plus may be provided for each engine cylinder.

The control module 130 is configured for communicating with the engine 110 by communicating with, in this particular example, injector 116 and valve 124. Other sensors such as exhaust gas recirculation valves, oxygen sensors, water sensors for the air mixture, and the like may be employed and additionally in communication with control module 130. In one or more embodiments, the control module 130 may be the existing control module that was installed with an engine being retrofit, or it may be an additional control module that communicates with the existing control module of the engine being retrofit, or it may be a control module that is provided to entirely replace the existing control module that was provided with the original engine being retrofit for gaseous fuel operation.

A battery or other power source may be provided in communication with engine module 460. Additionally, a computer diagnostic connector may also be provided in communication with the engine module. The diagnostic connector may be used to communicate with a monitoring computer that may monitor one or more performance characteristics of the system 400. Alternatively, a Bluetooth® or other wireless communications module may be provided to transmit in either near or far field the monitored characteristics. In this manner, the monitoring of the system performance may be done remotely. Additionally, programming updates may be transmitted to the engine module 460 in conjunction with monitoring of the engine and system performance.

In certain embodiments, two types of components are added to those already in the engine, such as an ignition control module and induction ignition coils. The ignition control module is connected to several induction ignition coils to control spark timing and spark duration during gaseous fuel operation. These two types of components are in addition to those already in the original engine. The timing and duration of spark is thereby adjusted to increase power output and achieve a more complete combustion, therefore lowering combustion emissions. An ignition coil is used for each spark plug 118 in the engine. The ignition coils control the spark duration. The ignition control module controls the spark ignition timing. The control module (ECM) controls the ignition control module by enabling it during gaseous fuel operation and disabling it during original liquid fuel operation. When the ECM enables the ignition control module, it simultaneously disables the ignition coils from the original engine. The original ignition coils are enabled only when the ECM disables the ignition control module.

The control module 130 is configured to monitor engine RPM. This may be done in any manner of ways, including monitoring the pulsing frequency of the fuel injector 116, monitoring the sparks from a given sparkplug, communicating with a tachometer to measure the same, or any other appropriately configured method.

The module 130 may monitor the engine speed or some other characteristic 502 based on any readings from the one or more gauges provided. Based on the monitored characteristics, the control module 130 then directs one or both of the fuel injector and the supply line valve to operate in a desired manner. For example, during engine startup, the control module 130 may direct the fuel injector to operate in a normal operating condition, meaning the condition that the fuel injector would operate in an engine that has not been retrofit or provided with the gaseous fuel systems disclosed herein. This would allow the engine to crank and idle on traditionally provided fuels such as diesel or gasoline. After a desired RPM or other characteristic is reached, the control module may then direct the fuel injector to cease injecting gasoline or diesel and then direct the valve to open to allow flow of a gaseous fuel through the supply line.

As illustrated, two gaseous fuel tanks 136 may be provided, while in other embodiments, any desired number may be provided. This is due to, during experimental testing, it was determined that the gaseous fuel line pressure was below a desirable level during high engine RPMs and the addition of a second fuel tank 136 alleviates this issue.

A coalescing filter may be provided in the gaseous fuel line. Fuel is provided through the gaseous fuel line into the gaseous fuel manifold where it is split into multiple fuel lines for communicating with each gaseous injector. The gaseous injector may be in communication with ECM 130 via sensor as previously described herein.

The ECM 130 may turn off of gasoline pumps. The ECM 130 may turn on water pump 442 in warming circuit 440 or other heater to moderate temperature of gaseous fuel components as already described herein.

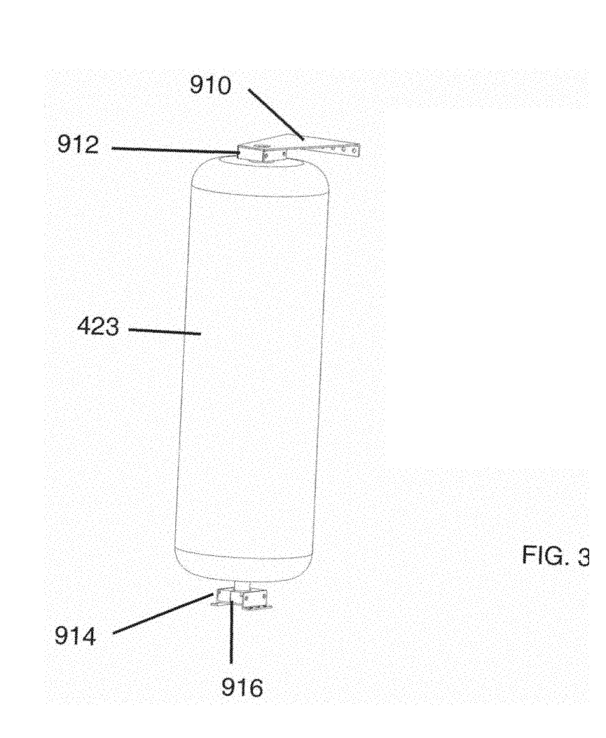

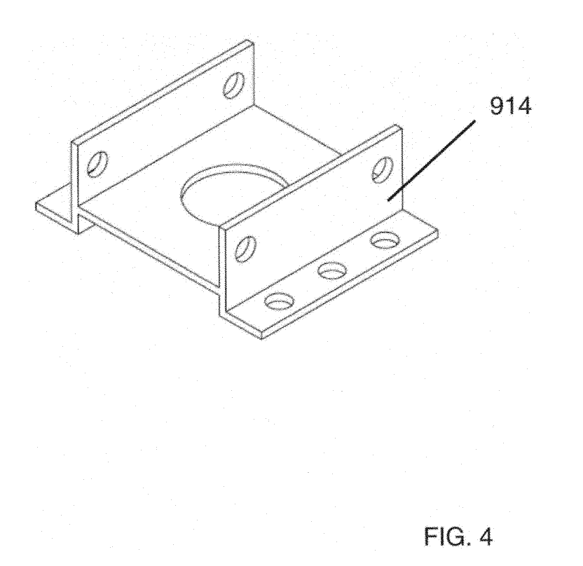

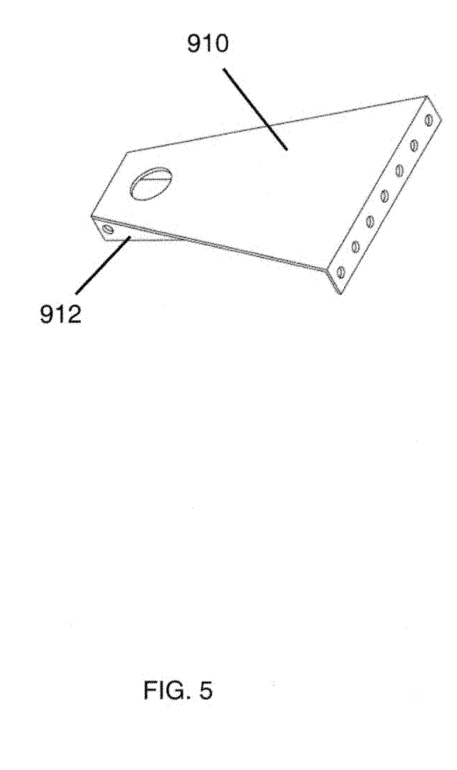

FIG. 3 illustrates the tank 423 of the tank module 420. As illustrated, the tank 423 may include a top bracket 910 that is configured, in at least one embodiment, for orienting the tank in a generally vertical arrangement. An insulating block 912 may be provided for pivoting about the top bracket 910 and securing to the tank 423 as illustrated in FIG. 4. A bottom bracket 914 may also be provided, which may also include an insulating block 916 as illustrated in FIG. 5.

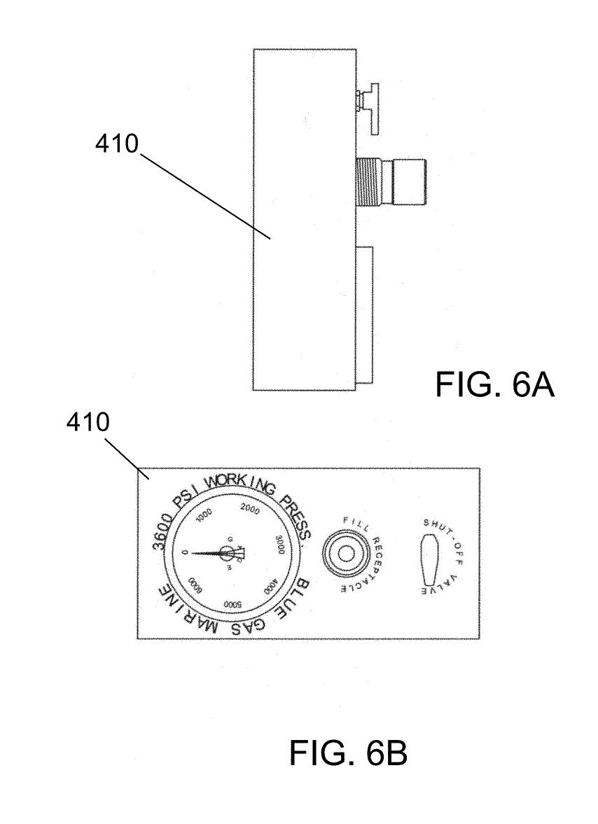

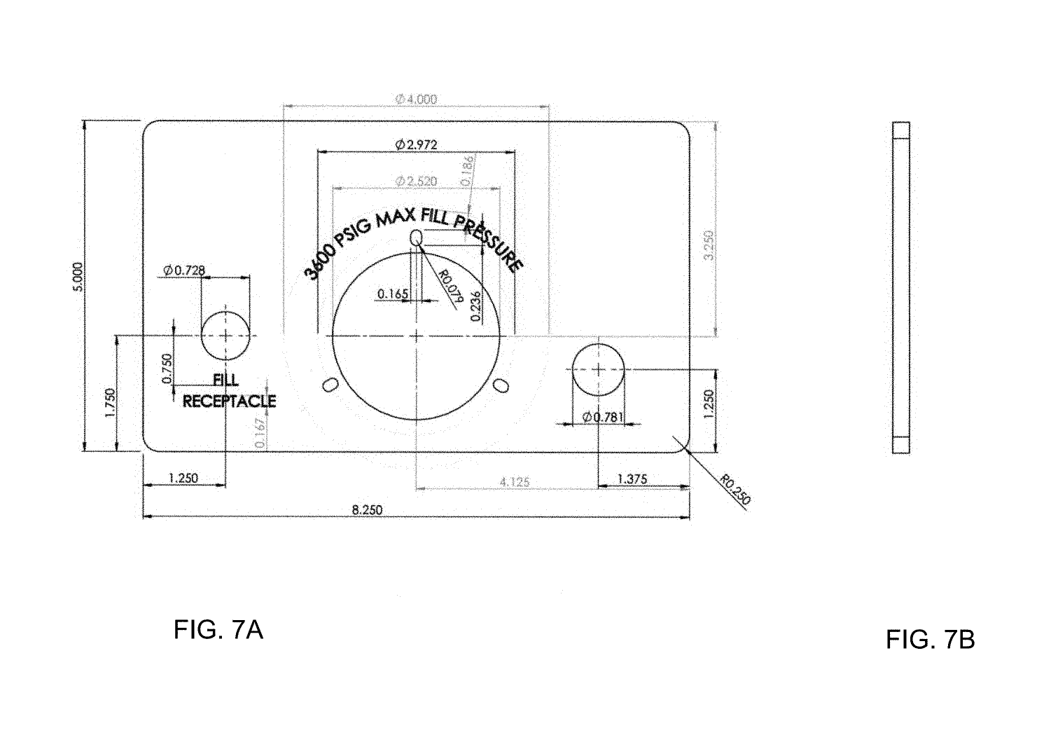

FIG. 6A, FIG. 6B, FIG. 7A, and FIG. 7B illustrate a side view of an installed fuel receiving panel 410. The panel 410 includes a fill receptacle and a pressure/level indicator. The fuel receiving panel 410 is configured such that the panel 410 is mounted onto a marine vehicle and into fluid communication with the tank module 420. In this manner, fueling, and defueling of the tank 423 may be accomplished. There is a knob connected to a manual shut-off valve on the back of the face plate. The purpose of this valve is to isolate the fueling nozzle from the rest of the high pressure plumbing going into the tanks. When it is turned ON, then CNG at high pressure (3600 PSI) goes past it and into the tanks, if a dispensing pump is filling the boat. When it is OFF no fuel can get into the tanks. The fueling nozzle itself has a one-way check-valve on the back of the plate, so the manual shutoff valve also acts as another safety measure to prevent that a malfunction of the check-valve would not cause fuel at high pressure to be discharged thru the fueling nozzle.

Each of the modules disclosed herein are advantageously provided in a kit for converting or retrofitting an engine running off of liquid fuel such as gasoline or diesel into running off of gaseous fluids. As such, a kit may include each of a fuel receiving module configured for being installed within a marine vehicle, the fuel receiving module including at least a fuel receptacle, a tank module for storing gaseous fuel, the tank module in communication with the fuel receiving module, a pressure reduction module configured for reducing a pressure of the gaseous fuel from the tank module to a pressure suitable for an engine of the marine vehicle, an engine module in communication with an engine control module for controlling operation of the engine, a helm control module in communication with the engine module and at least one other module for controlling operation of the system, and an ignition control module for providing ignition to the engine.

In one or more embodiments, the engine control module is configured to direct the engine module to crank the engine on natural gas from a stopped state without the injection of gasoline or diesel.

In one or more embodiments, the engine control module is configured to switch between gasoline or diesel and natural gas upon actuation of the helm control module by an operator.

In one or more embodiments, the engine control module is configured to switch to natural gas automatically or manually with the intervention of a human operator when the following conditions occur: safe operation condition is indicated by lack of methane leak detection via signal from methane detector sensors; gas-tight system detection condition is indicated via pressure maintenance measurement at the natural gas injection manifold via signal from pressure sensor; successful analog or digital data transfer with helm control and other essential module sensors takes place; and control module body-temperature is above a specified threshold.

In one or more embodiments, the engine control module is configured to: receive indication of a safe operating condition by a methane leak detector; receive indication of a gas-tight system via pressure maintenance measurement at a natural gas injection manifold from a pressure sensor; determine data transfer with the helm control module and at least one other module; and determine that the control module body-temperature is above a predetermined value.

In one or more embodiments, the control module is configured to shut off a natural gas injector and actuate the valve to the open position when the engine transitions from the natural gas injection to gasoline or diesel fuel source if: the indication by the methane leak detector is not safe; the indication from the pressure sensor is not gas-tight; it is determined that data transfer does not occur between the helm control module and at least one other module; or it is determined that the control body temperature is not above a predetermined value.

In one or more embodiments, the control module is configured to shut off natural gas injector and actuate the valve to the open position when the engine transitions from the natural gas injection to gasoline or diesel fuel source if any of the monitored sensor signals fall outside of their safe operation mode.

In one or more embodiments, the control module is configured to control ignition timing.

In one or more embodiments, the control module is configured to select original engine builder's ignition timing or a unique and new ignition timing.

In one or more embodiments, the control module is configured for controlling a fuel injector in fluid communication with a cylinder head of the engine and a supply line having a valve for controlling flow for controlling flow of gaseous flow therethrough; enabling the fuel injector when the engine is operating at a first predetermined operation condition; and enabling the valve when the engine is operating at a second predetermined operation condition. The first predetermined operation condition and the second predetermined operation condition include a revolutions per minute of the engine range that partially overlaps.

In one or more embodiments, the control module is configured for: controlling a fuel injector in fluid communication with a cylinder head of the engine and a supply line having a valve for controlling flow for controlling flow of gaseous flow therethrough; enabling the fuel injector when the engine is operating at a first predetermined operation condition; and enabling the valve when the engine is operating at a second predetermined operation condition. The first predetermined operation condition and the second predetermined operation condition include a revolutions per minute of the engine range that partially overlaps

In one or more embodiments, information is transferred between modules using analog and/or digital signals.

In one or more embodiments, the signals utilize CAN (controller Area Network) protocols.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating there from. Therefore, the disclosed embodiments should not be limited to any single embodiment, but rather should be construed in breadth and scope in accordance with the appended claims.

What is claimed:

1. A system comprising:
a fuel receiving module configured for being installed within a marine vehicle, the fuel receiving module including at least a fuel receptacle;
a tank module for storing gaseous fuel, the tank module in communication with the fuel receiving module;
a pressure reduction module configured for reducing a pressure of the gaseous fuel from the tank module to a pressure suitable for an engine of the marine vehicle;
an engine module in communication with an engine control module for controlling operation of the engine;
a helm control module in communication with the engine module and at least one other module for controlling operation of the system; and
an ignition control module for providing ignition to the engine.

2. The system according to claim 1, wherein the pressure reduction module is in communication with a heating module for applying heating to the pressure reduction module to prevent freezing thereof during pressure reduction caused by fuel discharge.

3. The system according to claim 1, wherein the heating module comprises a pump that is configured for being fluidly coupled to an ambient liquid supply, the pump pumping ambient liquid to the pressure reduction module when directed by the helm control module.

4. The system according to claim 1, wherein the engine module includes an injector adaptor for each cylinder of the engine, the injector adaptor comprising:
a body portion defining a chamber therein and having a first end configured for being received within the engine and a second end configured for engaging with the fuel injector; and
a fuel passage inlet having a first end spaced-apart from the body portion that is configured for fluid communication with a gaseous fuel supply and a second end terminating in an inlet opening defined in the body portion, the inlet opening defining an oblong shape and terminating in the body at a position below the bottom-most portion of the injector.

5. The system according to claim 1, wherein the engine module is configured for controlling a fuel injector in fluid communication with a cylinder head of the engine and a supply line having a valve for controlling flow of the gaseous fuel therethrough, the control module being configured to enable the fuel injector when the engine is operating at a first predetermined operation condition and configured to enable the valve when the engine is operating at a second predetermined operation condition, wherein the first predetermined operation condition is an engine RPM below a predetermined value.

6. The system according to claim 5, wherein the second predetermined operation condition is an engine RPM above a predetermined value.

7. The system according to claim 5, wherein the control module is configured to shut off the fuel injector and actuate the valve to the open position when the engine transitions from the first predetermined operation condition to the second predetermined operation condition such that the engine is cranked on gasoline or diesel from the respective gasoline or diesel fuel source but runs on gaseous fuel between a desired RPM range.

8. The system according to claim 5, wherein the engine control module is configured to actuate the valve to vary the duration of opening to vary the amount of gaseous fuel flowing therethrough.

9. The system according to claim 5, wherein the engine control module is configured to direct the engine module to crank the engine on natural gas from a stopped state without the injection of gasoline or diesel.

10. The system according to claim 5, wherein the engine control module is configured to switch between gasoline or diesel and natural gas upon actuation of the helm control module by an operator.

11. The system according to claim 5, wherein the engine control module is configured to switch to natural gas automatically or manually with the intervention of a human operator when the following conditions occur:
safe operation condition is indicated by lack of methane leak detection via signal from methane detector sensors;
gas-tight system detection condition is indicated via pressure maintenance measurement at the natural gas injection manifold via signal from pressure sensor;
successful analog or digital data transfer with helm control and other essential module sensors takes place; and
control module body-temperature is above a specified threshold.

12. The system according to claim 5, wherein the engine control module is configured to:
receive indication of a safe operating condition by a methane leak detector;
receive indication of a gas-tight system via pressure maintenance measurement at a natural gas injection manifold from a pressure sensor;
determine data transfer with the helm control module and at least one other module; and
determine that the control module body-temperature is above a predetermined value.

13. The system according to claim 12, wherein the control module is configured to shut off a natural gas injector and actuate the valve to the open position when the engine transitions from the natural gas injection to gasoline or diesel fuel source if:
(a) the indication by the methane leak detector is not safe;
(b) the indication from the pressure sensor is not gas-tight;
(c) it is determined that data transfer does not occur between the helm control module and at least one other module; or
(d) it is determined that the control body temperature is not above a predetermined value.

14. The system according to claim 13, wherein the control module is configured to shut off natural gas injector and actuate the valve to the open position when the engine transitions from the natural gas injection to gasoline or diesel fuel source if any of the monitored sensor signals fall outside of their safe operation mode described in a, b, c, and d.

15. The system according to claim 5, wherein the control module is configured to control ignition timing.

16. The system according to claim 15, wherein the control module is configured to select original engine builder's ignition timing or a unique and new ignition timing.

17. The system according to claim 1, wherein the control module is configured for:
controlling a fuel injector in fluid communication with a cylinder head of the engine and a supply line having a valve for controlling flow for controlling flow of gaseous flow therethrough;
enabling the fuel injector when the engine is operating at a first predetermined operation condition; and
enabling the valve when the engine is operating at a second predetermined operation condition,
wherein the first predetermined operation condition and the second predetermined operation condition include a revolutions per minute of the engine range that partially overlaps.

18. The system according to claim 12, wherein the control module is configured for:
controlling a fuel injector in fluid communication with a cylinder head of the engine and a supply line having a valve for controlling flow for controlling flow of gaseous flow therethrough;
enabling the fuel injector when the engine is operating at a first predetermined operation condition; and
enabling the valve when the engine is operating at a second predetermined operation condition,
wherein the first predetermined operation condition and the second predetermined operation condition include a revolutions per minute of the engine range that partially overlaps

19. A tank bracket system comprising:
a top bracket having a flange for being secured to a first mounting surface;
a first insulation block carried by the top bracket and defining a bottom-facing surface for engaging a top surface of a tank;
a bottom bracket having a flange for being secured to a second mounting surface; and
a second insulation block carried by the bottom bracket and configured for engaging with a bottom surface of the tank.

20. A method comprising:
receiving indication of a safe operating condition by a methane leak detector;
receiving indication of a gas-tight system via pressure maintenance measurement at a natural gas injection manifold from a pressure sensor;
determining or detecting data transfer with the helm control module and at least one other module; and
determining that the control module body-temperature is above a predetermined value.
